(19) United States
(12) Patent Application Publication
(10) Pub. No.: US 2023/0098356 A1
(43) Pub. Date: Mar. 30, 2023

(54) SYSTEMS AND METHODS FOR IDENTIFYING CANDIDATE VIDEOS FOR AUDIO EXPERIENCES

(71) Applicant: Meta Platforms, Inc., Menlo Park, CA (US)

(72) Inventors: Sonal Gandhi, Seattle, WA (US); Priyam Chatterjee, Los Gatos, CA (US); Nader Hamekasi, Mountain View, CA (US)

(21) Appl. No.: 17/490,953

(22) Filed: Sep. 30, 2021

(51) Int. Cl. H04N 21/2743; G06N 20/00; H04N 21/233; H04N 21/234

(52) U.S. Cl. CPC H04N 21/2743; G06N 20/00; H04N 21/233; H04N 21/23418

(57) ABSTRACT

A computer-implemented method for identifying candidate videos for audio experiences may include (i) identifying a video with audio content that is a candidate for an audio-primary user experience that enables users to consume the video by listening to the audio content without watching visual content of the video, (ii) determining, at least in part by analyzing the video via a machine learning algorithm, that the audio content of the video is suitable for the audio-primary user experience, and (iii) presenting the audio content of the video to at least one user via an interface designed for the audio-primary user experience in response to determining that the audio content of the video is suitable for the audio-primary user experience. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for identifying candidate videos for audio experiences.

FIG. 2 is a flow diagram of an exemplary method for identifying candidate videos for audio experiences.

FIG. 3 is an illustration of an exemplary library of candidate videos.

FIG. 4 is an illustration of exemplary interfaces for audio experiences.

FIG. 5 is an illustration of an exemplary system for identifying candidate videos for audio experiences.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The present disclosure is generally directed to systems and methods for identifying engaging video content that can be served as an audio-only or audio-primary experience. For example, a video where a relationship expert gives advice to viewers may be engaging to listeners in an audio-only format (e.g., as a podcast) while a video where an automotive expert demonstrates how to install a headlight may not be engaging or valuable in an audio-only or audio-primary format. In some cases, a platform may have a rich library of video content (e.g., videos uploaded by users to a social media platform) that may include potential candidate videos for audio-only or audio-primary experiences related to and/or hosted by the platform. In some examples, the systems described herein may analyze videos in the library and identify candidate videos for an audio-primary experience via machine learning. In one example, a machine learning algorithm may initially use heuristics such as quantity of speech in a video, level of visual complexity, and/or topic. Over time, the machine learning algorithm may be trained to identify additional characteristics that are indicative of an engaging audio-primary experience. In one embodiment, the systems described herein may automatically edit videos to be more engaging, for example by removing lengthy pauses where no audio occurs. In some embodiments, the systems described herein may use user engagement metrics to determine whether a video was successfully identified as engaging for an audio-only experience.

In some embodiments, the systems described herein may improve the functioning of a computing device by enabling the computing device to identify candidate videos for audio-primary experiences. In one embodiment, the systems described herein may improve the functioning of a computing device by providing the computing device with videos suitable for an audio-primary experience in an audio and/or video player of the computing device. Additionally, the systems described herein may improve the fields of streaming video and/or streaming audio by automatically identifying candidate videos for audio-primary experiences, increasing the amount of content available for streaming audio services and/or streaming video services intended to function in the background.

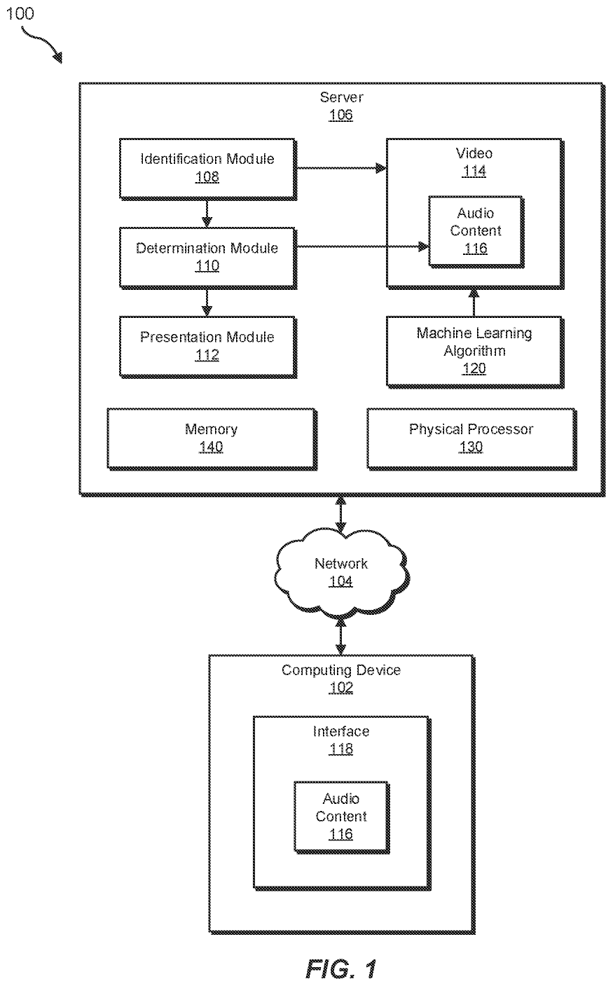

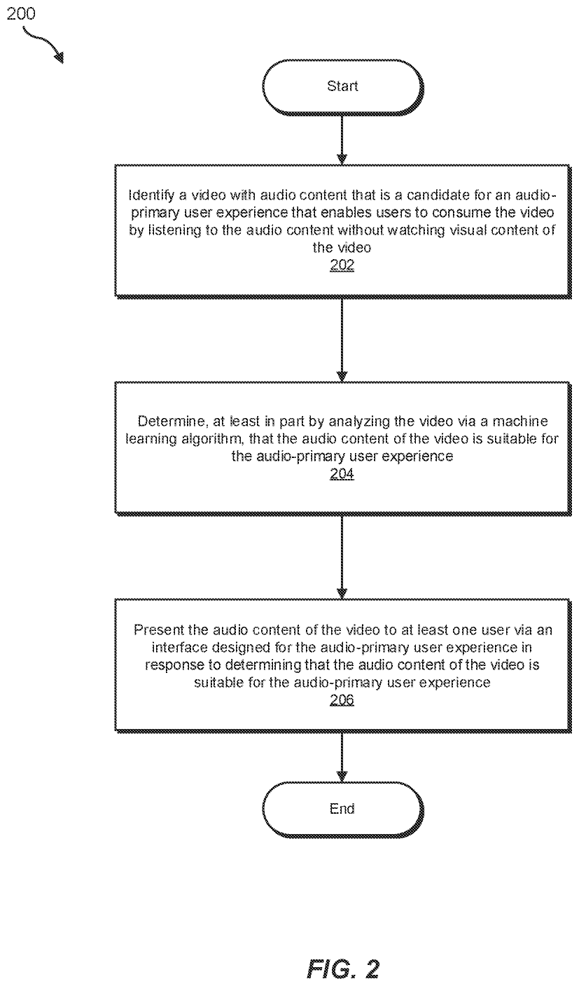

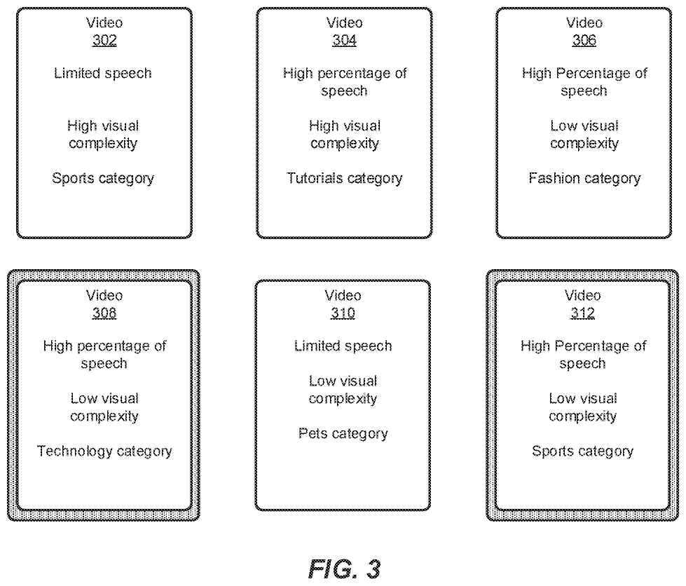

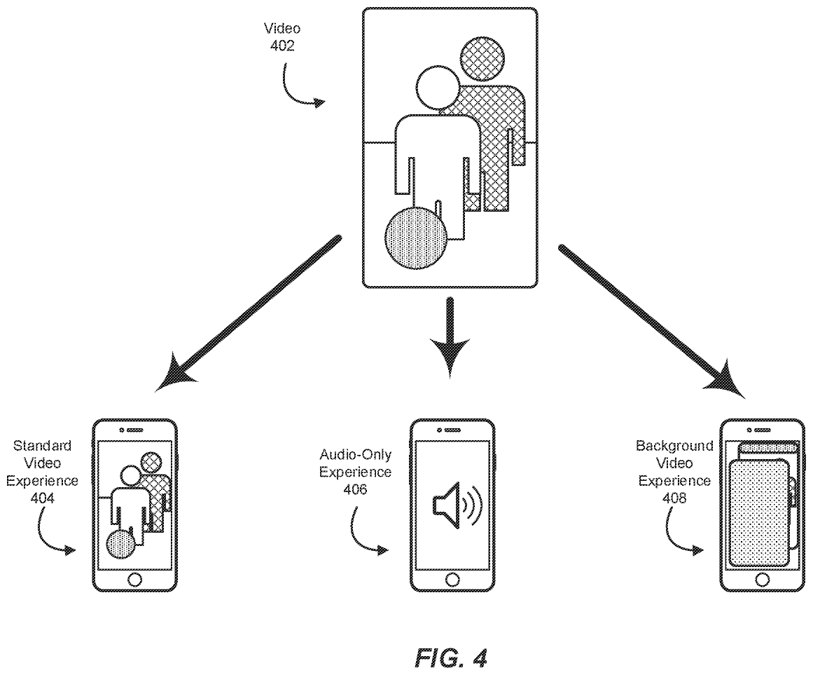

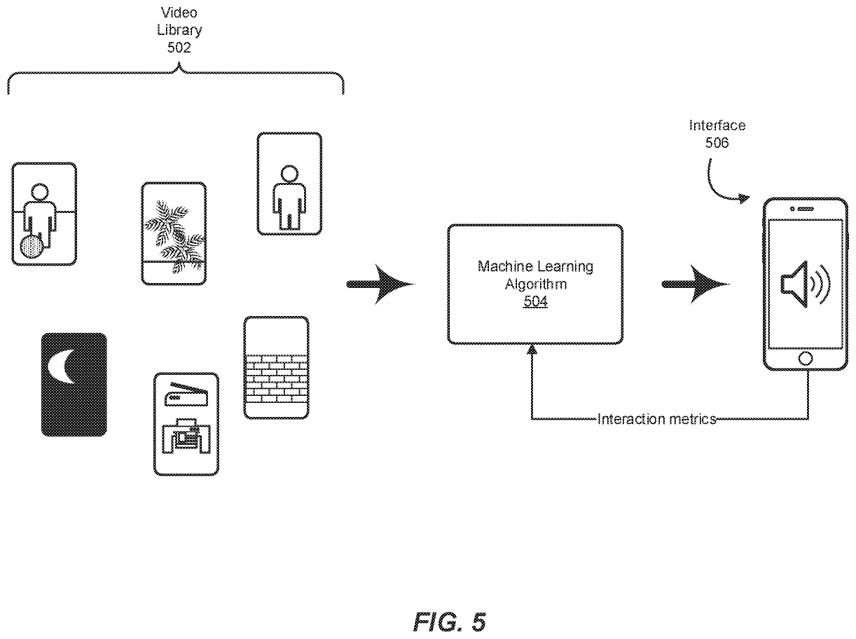

The following will provide detailed descriptions of systems and methods for identifying candidate videos for audio experiences with reference to FIGS. 1 and 2, respectively. Detailed descriptions of an example library of candidate videos will be provided in connection with FIG. 3. Detailed descriptions of example interfaces for various types of audio and/or video experiences will be provided in connection with FIG. 4. Additionally, detailed descriptions of an example system for identifying candidate videos via a machine learning algorithm that is updated based on user interaction data will be provided in connection with FIG. 5.

In some embodiments, the systems described herein may identify candidate videos that will be presented as audio-primary experiences via interfaces on end-user devices. FIG. 1 is a block diagram of an exemplary system 100 for identifying candidate videos for audio experiences. In one embodiment, and as will be described in greater detail below, a server 106 may be configured with an identification module 108 that may identify a video 114 with audio content 116 that is a candidate for an audio-primary user experience that enables users to consume video 114 by listening to audio content 116 without watching visual content of video 114. Next, a determination module 110 may determine, at least in part by analyzing video 114 via a machine learning algorithm 120, that audio content 116 of video 114 is suitable for the audio-primary user experience. In some examples, a presentation module 112 may present audio content 116 of video 114 to at least one user via an interface 118 designed for the audio-primary user experience in response to determining that audio content 116 of video 114 is suitable for the audio-primary user experience. For example, presentation module 112 may make audio content 116 available for download to a computing device 102 via a network 104.

Server 106 generally represents any type or form of backend computing device that may store, process, and/or analyze media files. Examples of server 106 may include, without limitation, application servers, database servers, media servers, and/or any other relevant type of server. Although illustrated as a single entity in FIG. 1, server 106 may include and/or represent a group of multiple servers that operate in conjunction with one another. In some embodiments, server 106 may host and/or be operated by a social networking platform.

Computing device 102 generally represents any type or form of computing device capable of reading computer-executable instructions. For example, computing device 102 may represent an end-user computing device. Additional examples of computing device 102 may include, without limitation, a laptop, a desktop, a tablet, a smart television, a smartphone, a wearable device, a smart device, an embedded device (e.g., a media player in a vehicle), an artificial reality device, a personal digital assistant (PDA), etc.

Video 114 generally represents any type or form of digital media that includes non-static visual content as well as audio content. In some examples, video 114 may be a live-action video (as opposed to, e.g., an animated video created digitally). In some embodiments, video 114 may be a video created and/or uploaded by a user of a platform, such as a user of a social media platform. In some examples, video 114 may have various attributes that are manually assigned by the creator and/or detected automatically, such as the topic of video 114 and/or tags applied to video 114.

Audio content 116 generally refers to one or more audio tracks of a video, such as video 114. In some embodiments, audio content 116 may be stored as part of a digital file that represents video 114. Additionally or alternatively, audio content 116 may be stored as a separate file from visual content and/or other content of video 114.

Interface 118 generally represents any type or form of user interface and/or media player capable of presenting audio and/or video to a user. In some embodiments, interface 118 may be a video player that is capable of presenting videos for a standard video experience (e.g., where a user watches the video while listening to the audio) and/or an audio-primary user experience (e.g., where a user listens to the audio without continuously watching the video). Additionally or alternatively, interface 118 may be an audio player that presents audio but does not present video. In some embodiments, interface 118 may be a specialized interface designed to present video for audio-primary experiences (e.g., in the background of other applications).

Machine learning algorithm 120 generally represents any type or form of machine learning algorithm, model, and/or classification system. In one example, machine learning algorithm 120 may include a neural network. In some embodiments, machine learning algorithm 120 may be trained on a set of labeled data (e.g., videos labeled as suitable or not suitable for an audio-primary experience) before being used to classify unlabeled data. Additionally or alternatively, machine learning algorithm 120 may be pre-configured with heuristics with which to classify videos. In some embodiments, machine learning algorithm 120 may be trained during use via feedback about the accuracy of classifications performed by machine learning algorithm 120. In some embodiments, the systems described herein may supplement machine learning algorithm 120 with online learning (e.g., learning based on user engagement metrics).

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

FIG. 2 is a flow diagram of an exemplary method 200 for identifying candidate videos for audio experiences. In some examples, at step 202, one or more of the systems described herein may identify a video with audio content that is a candidate for an audio-primary user experience that enables users to consume the video by listening to the audio content without watching visual content of the video. For example, identification module 108 may, as part of server 106 in FIG. 1, identify video 114 with audio content 116 that is a candidate for an audio-primary user experience that enables users to consume video 114 by listening to audio content 116 without watching visual content of video 114.

The term “audio-primary user experience” or “audio-primary experience” may generally refer to any interaction with audio content of a video in which presenting the audio content of the video the user is the primary function of the interface, in place of or secondary to presenting visual content of the video. For example, the systems described herein may facilitate an audio-primary user experience by presenting the audio content of a video to a user via an audio player that does not present the video content (e.g., as an audio-only user experience). In another example, the systems described herein may facilitate an audio-primary user experience by presenting both the visual and audio content of a video in an interface that requires minimal interaction from the user, enabling the user to listen to the audio content of the video without continuously watching the visual content of the video and/or the interface presenting the video. In some examples, an interface for an audio-primary user experience may automatically play videos in a sequence, enabling a user to listen to videos while performing other activities without interrupting those activities to interact with the interface.

Identification module 108 may identify the video in a variety of ways and/or contexts. For example, identification module 108 may access a library of videos stored on and/or related to a platform (e.g., videos uploaded by users of a video hosting service, media streaming service, and/or social networking platform) and may identify videos in the library. In some embodiments, identification module 108 may identify candidate videos in a library of videos not previously categorized relative to suitability for audio-primary experiences. In other embodiments, identification module 108 may identify candidate videos in a library of videos that has been pre-screened for suitability in some way (e.g., by removing any videos with no audio, by including only videos with suitable distribution rights, etc.).

At step 204, one or more of the systems described herein may determine, at least in part by analyzing the video via a machine learning algorithm, that the audio content of the video is suitable for the audio-primary user experience. For example, determination module 110 may, as part of server 106 in FIG. 1, determine, at least in part by analyzing video 114 via machine learning algorithm 120, that audio content 116 of video 114 is suitable for the audio-primary user experience.

Determination module 110 may determine that the audio content of the video is suitable in a variety of ways. For example, determination module 110 may determine that the audio content of the video is suitable based solely on the classification arrived at by the machine learning algorithm. In some examples, determination module 110 may apply one or more heuristics before or after analysis by the machine learning model, such as pre-emptively filtering out videos tagged with certain topics generally not suitable to audio-primary experiences (e.g., visual tutorials such as cooking, makeup, or automotive maintenance). In some embodiments, determination module 110 may incorporate manually applied tags and/or classifications by one or more analysts. For example, determination module 110 may flag a video for manual review and then collect metrics such as whether the audio content of the video was enjoyable, understandable, and/or engaging to the analyst.

In some embodiments, determination module 110 may use various heuristics to determine if a video is suitable for an audio-primary experience. In one embodiment, determination module 110 may use heuristics such as the topic or category of the video, the visual complexity of the video, and/or the amount of human speech in the audio of the video. For example, the systems described herein may have a list of topics that are generally not suitable for an audio-primary experience due to relying heavily on visual content (e.g., visual tutorials, cute animals, fashion, etc.), a list of topics that are sometimes suitable for an audio-primary experience and sometimes not (e.g., sports, theater, etc.), and/or a list of topics that are generally suitable for an audio-primary experience (e.g., relationship advice, talk shows, political commentary, etc.). In some embodiments, the systems described herein may filter first based on topic before filtering on other heuristics, such whether the visual complexity falls below a predetermined threshold for visual complexity. The systems described herein may measure the visual complexity of a video by any appropriate method, such as the ratio of high-definition encoding to standard-definition encoding file sizes of the video. In some embodiments, the systems described herein may determine the quantity and/or percentage of human speech audible in the audio content and may only mark the video as suitable if the video meets a threshold for quantity of human speech. In some examples, the systems described herein may filter by the language of the speech, such as whether the speech is in English. Additionally or alternatively, the systems described herein may determine the quantity of music in the audio of a video and mark videos with a sufficiently high percentage of music (alone or in combination with speech) as suitable. In some embodiments, the systems described herein may use additional information about the video, such as the title, description, tags, category, and/or publisher, to determine whether to categorize the music as background music (and therefore not count the music towards suitable audio content) or filler music (and therefore count the music towards suitable audio content).

In some embodiments, the systems described herein may use the above-described heuristics and/or other heuristics consecutively or concurrently (e.g., by weighting the heuristics) to determine if videos are suitable. For example, as illustrated in FIG. 3, determination module 110 may make determinations about videos 302, 304, 306, 308, 310, and/or 312. In one example, video 302 may have limited speech in the audio content, high visual complexity, and be in the “sports” category. While being in the “sports” category may not automatically disqualify video 302, the low speech content and high visual complexity may indicate that video 302 is unsuitable for an audio-primary experience. For example, video 302 may be a replay of a complex football play with little commentary. By contrast, video 312, despite being in the sports category, may have low visual complexity and high speech content and the systems described herein may determine that video 312 is suitable for an audio-primary experience. For example, video 312 may portray a panel of commentators discussing a sporting event.

In one example, the systems described herein may determine that videos 304, 306, and/or 310 are not suitable due to category, speech content, and/or complexity. For example, video 304 may portray a makeup tutorial that is difficult to follow without visual content, video 306 may be a discussion of a slideshow of dresses that has limited engagement value without being able to see the dresses, and/or video 310 may be a video of a puppy repeatedly falling over that is engaging to watch but not to listen to. In one example, the systems described herein may determine that video 308 is suitable due to the high speech content, low complexity, and placement in the “technology” category. For example, video 310 may feature a technology expert discussing the home network vulnerabilities posed by malicious toasters and other malware-infected smart devices and thus may be engaging as an audio-primary experience.

At step 206, one or more of the systems described herein may present the audio content of the video to at least one user via an interface designed for the audio-primary user experience in response to determining that the audio content of the video is suitable for the audio-primary user experience. For example, presentation module 112 may, as part of server 106 in FIG. 1, present audio content 116 of video 114 to at least one user via interface 118 designed for the audio-primary user experience in response to determining that audio content 116 of video 114 is suitable for the audio-primary user experience.

Presentation module 112 may present the audio content in a variety of different ways. In one embodiment, presentation module 112 may present the audio content by making the audio content available for download to an end-user device which then presents the audio content via an interface. In some examples, presentation module 112 may present the audio content via an interface designed to present audio and/or video content to a user.

In some examples, presentation module 112 may present both visual and audio content, while in other examples, presentation module 112 may present only audio content and not visual content. For example, as illustrated in FIG. 4, the systems described herein may determine that a video 402 is suitable for an audio-primary experience. In one embodiment, the systems described herein may add video 402 to a library of audio-primary videos that may be presented in a variety of ways.

In one example, the systems described herein may present video 402 as a standard video experience 404 that enables a user to watch visual content of video 402 while listening to audio content of video 402. For example, the systems described herein may present video 402 via a video player on a video streaming platform. In another example, the systems described herein may present video 402 as an audio-only experience 406 that enables a user to listen to audio content of video 402 without watching visual content of video 402. For example, the systems described herein may present video 402 via a podcast player or other audio player. In another example, the systems described herein may present video 402 via a background video experience 408 that enables a user to place the application and/or interface presenting video 402 in the background while another application is in the foreground (e.g., has focus and/or is visibly eclipsing the application and/or interface presenting video 402). In some examples, background video experience 408 may enable a user to switch between actively watching visual content and passively listening to audio content.

In one embodiment, the systems described herein may automatically play the audio and/or visual content of a new video after a previous video ends, without requiring user interaction to begin the new video. In some embodiments, the systems described herein may detect that a user has not interacted with a media presentation interface for a predetermined amount of time and/or videos (e.g., three minutes, five minutes, two videos, five videos, etc.) and may switch from presenting arbitrary videos (e.g., videos that may or may not be suitable for an audio-primary experience) to videos suitable for an audio-primary experience. Additionally or alternatively, the systems described herein may switch to presenting only videos suitable for an audio-primary experience in response to the state of the media presentation interface. For example, if the interface is in the background, the systems described herein may switch to presenting only videos suitable for an audio-primary experience. In some embodiments, the systems described herein may select suitable videos using the same algorithm used to select arbitrary videos (e.g., auto-playing sports videos if the user was watching sports videos, auto-playing relationship advice videos if the user was watching a relationship advice video, etc.).

In some embodiments, the systems described herein may monitor the interactions of at least one user with the video and, based on the presence and/or type of interaction, may mark the video as not suitable for the audio-primary user experience or as confirmed suitable for the audio-primary user experience. In one embodiment, the systems described herein may determine that any interaction with the interface indicates that the user is no longer passively listening to the video and thus the video is not suitable. Additionally or alternatively, the systems described herein may weight specific interactions, such as skipping the video, closing the interface, and/or choosing a different video, as negative interactions and may mark a video as not suitable if the video's score meets a threshold for negative interactions. In some embodiments, the systems described herein may compare user interactions with a video presented as part of an audio-primary experience with user interactions with the same video presented as part of a standard video experience to determine whether a video is suitable. For example, if 20% of users skip the video during a standard video experience and 22% skip the video during an audio-primary experience, the systems described herein may determine that users are interacting similarly with the video and the video is suitable for the audio-primary experience. However, if 20% of users skip the video during a standard video experience and 50% skip the video during an audio-primary experience, the systems described herein may determine that something about the video must not be engaging in an audio-primary experience and may mark the video as not suitable.

In some embodiments, the systems described herein may improve the machine learning model over time based at least in part on interactions of users. For example, as illustrated in FIG. 5, the systems described herein may identify a video library 502 of potentially suitable videos. In some examples, video library 502 may include all videos accessible to a platform. In other embodiments, video library 502 may be populated based on certain metrics, such as the most popular videos (as measured by user engagement) each day. In one example, a machine learning algorithm 504 may classify the videos in video library 502 as suitable or not suitable for an audio-primary experience. In some examples, the systems described herein may present suitable videos via an interface 506. The systems described herein may monitor user interactions with interface 506 and may train machine learning algorithm 504 with updated labeled training data generated by determining whether user interaction with a given video confirms that the video is suitable or indicates that the video is not suitable. In some embodiments, the systems described herein may monitor user interactions such as the amount of time a video is played in full screen versus minimized mode, the amount of time the video is played by users with visual impairments, the amount of time that sound is on when users play the video, and/or time spent by users with the video player on the screen.

In some embodiments, in addition to categorizing videos as suitable or not suitable, the systems described herein may categorize videos as suitable pending editing. For example, the systems described herein may detect that a percentage of the audio content that is suitable for the audio-primary user experience exceeds a minimum threshold for suitable audio but that another percentage of the audio content is not suitable and, in response, the systems described herein may categorize the video as suitable pending editing. In one example, audio content of a video may mostly consist of human speech but may have one or more periods of silence, static, white noise, and/or other non-speech background noise. In this example, the human speech may be audio content that is suitable and the silence or background noise may be audio content that is not suitable. In some embodiments, the systems described herein may flag the video for manual editing. Additionally or alternatively, the systems described herein may automatically edit the video to be suitable for the audio-primary user experience. For example, the systems described herein may remove the periods of silence and stitch together the remaining portions of the content, resulting in shorter content that is entirely suitable. In some embodiments, the systems described herein may substantially edit a video. For example, the systems described herein may split a longer video into multiple shorter videos that are suitable for an audio-primary experience. In one example, the systems described herein may cut a forty-minute-long video-blog into five two-minute-long highlight segments that are suitable for an audio-primary experience.

As described above, the systems and methods described herein may automatically select videos within a pre-existing video library that are suitable for an audio-primary user experience. In some examples, a media streaming service, social media platform, or other organization may have access to a large library of videos, some of which are only engaging when presented with visual content and others of which are engaging when a user passively listens to the audio content while occasionally glancing at or even entirely ignoring the visual content. For example, users may listen to videos in the background while exercising, driving, cooking, or performing other activities. By automatically identifying suitable videos for an audio-primary experience, the systems described herein may populate audio-primary services and/or interfaces with a rich media library. In some examples, the systems described herein may improve the user experience of users listening to videos in the background by providing the users with videos with engaging audio content.

### EXAMPLE EMBODIMENTS

Example 1: A method for identifying candidate videos for audio experiences may include (i) identifying a video with audio content that is a candidate for an audio-primary user experience that enables users to consume the video by listening to the audio content without watching visual content of the video, (ii) determining, at least in part by analyzing the video via a machine learning algorithm, that the audio content of the video is suitable for the audio-primary user experience, and (iii) presenting the audio content of the video to at least one user via an interface designed for the audio-primary user experience in response to determining that the audio content of the video is suitable for the audio-primary user experience.

Example 2: The computer-implemented method of example 1, where identifying the video with the audio content that is the candidate for the audio-primary user experience includes selecting the video from a library of user-uploaded videos on a platform that hosts the user-uploaded videos.

Example 3: The computer-implemented method of examples 1-2, where determining that the audio content of the video is suitable for the audio-primary user experience includes determining that the audio content includes an amount of human speech that meets a threshold for speech content.

Example 4: The computer-implemented method of examples 1-3, where determining that the audio content of the video is suitable for the audio-primary user experience includes determining that visual content of the video falls below a predetermined threshold for visual complexity.

Example 5: The computer-implemented method of examples 1-4, where determining that the audio content of the video is suitable for the audio-primary user experience includes identifying a category of the video and determining that the category of the video is suitable for the audio-primary user experience.

Example 6: The computer-implemented method of examples 1-5, where determining that the audio content of the video is suitable for the audio-primary user experience includes flagging the video for manual review.

Example 7: The computer-implemented method of examples 1-6, where the interface designed for the audio-primary user experience includes an audio player that presents the audio content of the video without visual content of the video.

Example 8: The computer-implemented method of examples 1-7, where the interface designed for the audio-primary user experience includes a background application configured to present the audio content of the video while the background application is not in the foreground of a user interface for a device.

Example 9: The computer-implemented method of examples 1-8, where presenting the audio content of the video to the at least one user includes monitoring interactions of the at least one user with the video to confirm that the audio content of the video is suitable for the audio-primary user experience.

Example 10: The computer-implemented method of examples 1-9 may further include detecting that the at least one user has performed an interaction with the video via the interface and, in response to detecting the interaction, marking the video as not suitable for the audio-primary user experience.

Example 11: The computer-implemented method of examples 1-10, where determining that the audio content of the video is suitable for the audio-primary user experience includes detecting that a percentage of the audio content that is suitable for the audio-primary user experience exceeds a minimum threshold for suitable audio but that another percentage of the audio content is not suitable and categorizing the video as suitable pending editing.

Example 12: The computer-implemented method of examples 1-11 may further include, in response to categorizing the video as suitable pending editing, automatically editing the video to be suitable for the audio-primary user experience.

Example 13: The computer-implemented method of examples 1-12, where categorizing the video as suitable pending editing includes detecting at least one period of silence within the audio content and further including automatically editing the video to remove a portion of the video comprising the at least one period of silence.

Example 14: A system for identifying candidate videos for audio experiences may include at least one physical processor and physical memory including computer-executable instructions that, when executed by the physical processor, cause the physical processor to (i) identify a video with audio content that is a candidate for an audio-primary user experience that enables users to consume the video by listening to the audio content without watching visual content of the video, (ii) determine, at least in part by analyzing the video via a machine learning algorithm, that the audio content of the video is suitable for the audio-primary user experience, and (iii) present the audio content of the video to at least one user via an interface designed for the audio-primary user experience in response to determining that the audio content of the video is suitable for the audio-primary user experience.

Example 15: The system of example 14, where identifying the video with the audio content that is the candidate for the audio-primary user experience includes selecting the video from a library of user-uploaded videos on a platform that hosts the user-uploaded videos.

Example 16: The system of examples 14-15, where determining that the audio content of the video is suitable for the audio-primary user experience includes determining that the audio content includes an amount of human speech that meets a threshold for speech content.

Example 17: The system of examples 14-16, where determining that the audio content of the video is suitable for the audio-primary user experience includes determining that visual content of the video falls below a predetermined threshold for visual complexity.

Example 18: The system of examples 14-17, where determining that the audio content of the video is suitable for the audio-primary user experience includes identifying a category of the video and determining that the category of the video is suitable for the audio-primary user experience.

Example 19: The system of examples 14-18, where determining that the audio content of the video is suitable for the audio-primary user experience includes flagging the video for manual review.

Example 20: A non-transitory computer-readable medium may include one or more computer-readable instructions that, when executed by at least one processor of a computing device, cause the computing device to (i) identify a video with audio content that is a candidate for an audio-primary user experience that enables users to consume the video by listening to the audio content without watching visual content of the video, (ii) determine, at least in part by analyzing the video via a machine learning algorithm, that the audio content of the video is suitable for the audio-primary user experience, and (iii) present the audio content of the video to at least one user via an interface designed for the audio-primary user experience in response to determining that the audio content of the video is suitable for the audio-primary user experience.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
identifying a video with audio content that is a candidate for an audio-primary user experience that enables users to consume the video by listening to the audio content without watching visual content of the video;
determining, based at least in part on an analysis of the video via a machine learning algorithm and on a heuristic analysis of the video performed before or after the analysis via the machine learning algorithm, that the audio content of the video is suitable for the audio-primary user experience; and
presenting the audio content of the video to at least one user via an interface designed for the audio-primary user experience in response to determining that the audio content of the video is suitable for the audio-primary user experience.

2. The computer-implemented method of claim 1, wherein identifying the video with the audio content that is the candidate for the audio-primary user experience comprises selecting the video from a library of user-uploaded videos on a platform that hosts the user-uploaded videos.

3. The computer-implemented method of claim 1, wherein determining that the audio content of the video is suitable for the audio-primary user experience comprises determining that the audio content comprises an amount of human speech that meets a threshold for speech content.

4. The computer-implemented method of claim 1, wherein determining that the audio content of the video is suitable for the audio-primary user experience comprises determining that visual content of the video falls below a predetermined threshold for visual complexity.

5. The computer-implemented method of claim 1, wherein determining that the audio content of the video is suitable for the audio-primary user experience comprises:
identifying a category of the video; and
determining that the category of the video is suitable for the audio-primary user experience.

6. The computer-implemented method of claim 1, wherein determining that the audio content of the video is suitable for the audio-primary user experience comprises flagging the video for manual review.

7. The computer-implemented method of claim 1, wherein the interface designed for the audio-primary user experience comprises an audio player that presents the audio content of the video without visual content of the video.

8. The computer-implemented method of claim 1, wherein the interface designed for the audio-primary user experience comprises a background application configured to present the audio content of the video while the background application is not in a foreground of a user interface for a device.

9. The computer-implemented method of claim 1, wherein presenting the audio content of the video to the at least one user comprises monitoring interactions of the at least one user with the video to confirm that the audio content of the video is suitable for the audio-primary user experience.

10. The computer-implemented method of claim 9, further comprising:
detecting that the at least one user has performed an interaction with the video via the interface; and
in response to detecting the interaction, marking the video as not suitable for the audio-primary user experience.

11. The computer-implemented method of claim 1, wherein determining that the audio content of the video is suitable for the audio-primary user experience comprises:
detecting that a percentage of the audio content that is suitable for the audio-primary user experience exceeds a minimum threshold for suitable audio but that another percentage of the audio content is not suitable; and
categorizing the video as suitable pending editing.

12. The computer-implemented method of claim 11, further comprising, in response to categorizing the video as suitable pending editing, automatically editing the video to be suitable for the audio-primary user experience.

13. The computer-implemented method of claim 11:
wherein categorizing the video as suitable pending editing comprises detecting at least one period of silence within the audio content; and
further comprising automatically editing the video to remove a portion of the video comprising the at least one period of silence.

14. A system comprising:
at least one physical processor; and
physical memory comprising computer-executable instructions that, when executed by the physical processor, cause the physical processor to:
identify a video with audio content that is a candidate for an audio-primary user experience that enables users to consume the video by listening to the audio content without watching visual content of the video;
determine, based at least in part on an analysis of the video via a machine learning algorithm and on a heuristic analysis of the video performed before or after the analysis via the machine learning algorithm, that the audio content of the video is suitable for the audio-primary user experience; and
present the audio content of the video to at least one user via an interface designed for the audio-primary user experience in response to determining that the audio content of the video is suitable for the audio-primary user experience.

15. The system of claim 14, wherein identifying the video with the audio content that is the candidate for the audio-primary user experience comprises selecting the video from a library of user-uploaded videos on a platform that hosts the user-uploaded videos.

16. The system of claim 14, wherein determining that the audio content of the video is suitable for the audio-primary user experience comprises determining that the audio content comprises an amount of human speech that meets a threshold for speech content.

17. The system of claim 14, wherein determining that the audio content of the video is suitable for the audio-primary user experience comprises determining that visual content of the video falls below a predetermined threshold for visual complexity.

18. The system of claim 14, wherein determining that the audio content of the video is suitable for the audio-primary user experience comprises:
identifying a category of the video; and
determining that the category of the video is suitable for the audio-primary user experience.

19. The system of claim 14, wherein determining that the audio content of the video is suitable for the audio-primary user experience comprises flagging the video for manual review.

20. A non-transitory computer-readable medium comprising one or more computer-readable instructions that, when executed by at least one processor of a computing device, cause the computing device to:
identify a video with audio content that is a candidate for an audio-primary user experience that enables users to consume the video by listening to the audio content without watching visual content of the video;
determine, based at least in part on an analysis of the video via a machine learning algorithm and on a heuristic analysis of the video performed before or after the analysis via the machine learning algorithm, that the audio content of the video is suitable for the audio-primary user experience; and
present the audio content of the video to at least one user via an interface designed for the audio-primary user experience in response to determining that the audio content of the video is suitable for the audio-primary user experience.
